(19) United States
(12) Patent Application Publication
(10) Pub. No.: US 2018/0015696 A1
(43) Pub. Date: Jan. 18, 2018

(54) ADHESIVE ELEMENT WITH A DOUBLE BOND

(71) Applicant: Adhex Technologies, Chenôve (FR)

(72) Inventor: Hervé Durand, Dijon (FR)

(73) Assignee: Adhex Technologies, Chenôve (FR)

(21) Appl. No.: 15/648,054

(22) Filed: Jul. 12, 2017

(30) Foreign Application Priority Data
Jul. 13, 2016 (FR) 1656790

(51) Int. Cl. B32B 7/14; B32B 37/12; B32B 7/02; C09J 7/02; E04D 12/00; E04B 1/62

(52) U.S. Cl. CPC B32B 7/14; E04D 12/002; E04B 1/625; B32B 7/02; C09J 7/0246; B32B 37/1292; C09J 2423/006

(57) ABSTRACT

An adhesive element including at least one flexible support comprising an upper face and a lower face, and a first layer of a pressure-sensitive adhesive deposited on all or part of the lower face of the support and having a resistance to peeling greater than or equal to 2.6 N/cm according to the ASTM D3330 test method of the AAMA 711 standard at a temperature comprised between −30 and 23° C., and a second layer of a second pressure-sensitive adhesive deposited on said first layer and/or on all or part of the lower face of the support, the second pressure-sensitive adhesive of the second layer being different from the first adhesive and having a resistance to peeling greater than or equal to 2.6 N/cm according to the ASTM D3330 test method of the AAMA 711 standard at a temperature comprised between 0 and 70° C.

### BACKGROUND

The present invention relates to an adhesive element with a double bond and more particularly to an adhesive membrane which is a barrier against air and humidity and permeable to water vapor, intended for surfaces of buildings.

In the field of the construction of buildings, the use of adhesive membranes which are airproof and moisture-proof barriers and permeable to water vapor is well known, said membranes being interposed between the layers of the structural wall of the building in order to avoid problems due to accumulation of moisture.

These membranes generally comprise a membrane permeable to water vapor coated on one side by an adhesive. These membranes also form barriers against air and moisture, the microporous structure of the membranes allowing the passing of water vapor while preventing the passing of air. Indeed, the molecular structure of water vapor allows it to pass through smaller pores than oxygen and nitrogen notably.

Said membranes are attached on the walls of the building by means of the adhesive layer, usually a pressure-sensitive adhesive with an overlap of two adjacent membranes to ensure the seal.

Such membranes are notably marketed by 3M under references 3015 VP or 3015 AVB or by SOPREMA under the trademark of “Sopraseal Stick VP®” or else further described in documents U.S. Pat. No. 5,895,301 and U.S. Pat. No. 6,901,712.

Document U.S. Pat. No. 5,895,301 describes a barrier laminate tearable manually intended for obturating an interstice or a joint in a construction comprising a reinforcing mat having a first traction-resistance, a plain flexible cellulose strip to the reinforcement mat, which may be penetrated by liquids in its non-treated condition, and having a second resistance to traction which is less than the first traction-resistance, a polymeric resin resisting to the water applied on the strip for making it resistant to liquid water while allowing water vapor to cross it. The reinforcement mat contains polyester, rayon, glass fibers or a combination of these fibers and the polymeric resin is infiltrated into the strip in order to reduce the dimension of the pores of the latter for practically preventing the passage of liquid water.

This type of membrane has the drawback of being expensive to produce and of not providing perfect seal to air laterally. Moreover, this membrane does not have a good sizing according to the weather conditions during the laying of the membrane, notably when the temperature is negative during the pose.

Document U.S. Pat. No. 6,901,712 as for it describes an adhesive membrane which is airproof and moisture-proof barrier and permeable to water vapor intended for structural surfaces of buildings and which lets through water vapor. Said membrane consists of a sheet permeable to water vapor, on a surface of which is applied a discontinuous adhesive film.

Although this type of membrane has the advantage of providing a good seal to air laterally, it nevertheless has the drawback of being expensive to produce and not having good sizing depending on the weather conditions during the laying of the membrane.

Indeed, in order to allow sizing of these membranes at low temperatures, i.e. at temperatures of less than −15° C., it is necessary to apply beforehand on the support, i.e. the walls of the building, a so called primary layer marketed by SOPREMA under the name of “Elastocol Stick” or under the name of “Sopraseal®” for example. This preliminary treatment, although improving the resistance to peeling at low temperatures, has the drawback of not providing a totally sufficient peeling resistance between −30° C. and 70° C. and burdening the cost for laying these membranes.

It should be noted that this sizing problem depending on weather conditions is inherent to other adhesive elements comprising a support, permeable to water vapor or not, and a layer of a pressure-sensitive adhesive, such as adhesive tapes, adhesive ribbons, adhesive films, or the like.

One of the objects of the invention is therefore to find a remedy to these drawbacks by proposing an adhesive membrane which is airproof and moisture-proof barrier and permeable to water vapor, intended for surfaces of buildings, of simple design and not very expensive, providing good adherence on the walls of the building regardless of the outdoor temperature during the laying and a good seal to air laterally.

For this purpose and according to the invention, an adhesive element is proposed including at least one flexible support comprising an upper face and a lower face, and a pressure-sensitive adhesive layer deposited on the lower face of said support; said adhesive element is remarkable in that it includes a first layer of a pressure-sensitive adhesive deposited on all or part of the lower face of the support, the pressure-sensitive adhesive of the first layer having a peeling resistance greater than or equal to 2.6 N/cm according to the test method ASTM D3330 of the standard AAMA 711 at a temperature comprised between −30 and 23° C., and a second layer of a second pressure-sensitive adhesive deposited on said first layer and/or on all or part of the lower face of the film, the second pressure-sensitive adhesive of the second layer being different from the first adhesive and having a peeling resistance greater than or equal to 2.6 N/cm according to the test method ASTM D3330 of the AAMA 711 standard at a temperature comprised between 0 and 70° C.

Preferably, the first layer of pressure-sensitive adhesive is deposited on the totality of the lower face of the support over a thickness of less than or equal to 50 μm.

According to an alternative embodiment of the invention, the first and/or the second pressure-sensitive adhesive layer are deposited as horizontal and/or vertical and/or diagonal strips.

According to an alternative embodiment of the invention, the second pressure-sensitive adhesive layer is deposited on horizontal and/or vertical and/or diagonal cords.

Preferably, the first and second pressure-sensitive adhesive layers are deposited as diagonal cords for forming interlaced crosspieces.

For an application to an adhesive membrane which is a barrier against air and humidity and permeable to water vapor, intended for surfaces of buildings, said support consists in a film permeable to water vapor.

Further, said film includes at least one microporous film or a composite of the latter and/or at least one oriented polymeric film or a composite of the latter and/or at least one polyolefin film or a composite of the latter and/or at least one polypropylene film or a composite of the latter and/or at least one film in polyolefin which is non-woven and a composite of the latter.

Accessorily, the adhesive element includes a protective film capping the second layer of pressure-sensitive adhesive.

One of the applications of the adhesive element according to the invention consists in an adhesive membrane which is a barrier against air and humidity and permeable to water vapor, intended for surfaces of buildings.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 is a perspective view of an adhesive membrane which is airproof and moisture-proof barrier and permeable to water vapor according to the invention,

FIG. 2 is an elevational view of an adhesive membrane which is airproof and moisture-proof barrier and permeable to water vapor according to the invention,

FIG. 3 is a view from below of an adhesive membrane which is airproof and moisture-proof barrier and permeable to water vapor according to the invention.

### DETAILED DESCRIPTION

While illustrative embodiments have been illustrated and described, it will be appreciated that various changes can be made therein without departing from the spirit and scope of the invention.

An adhesive membrane which is airproof and moisture-proof barrier and permeable to water vapor will be described hereafter, intended for surfaces of buildings; however, it is quite obvious that the invention may be applied to any other adhesive element comprising a support, permeable to water vapor or not, and a layer of a pressure-sensitive adhesive, such as adhesive tapes, adhesive ribbons, adhesive films, or the like.

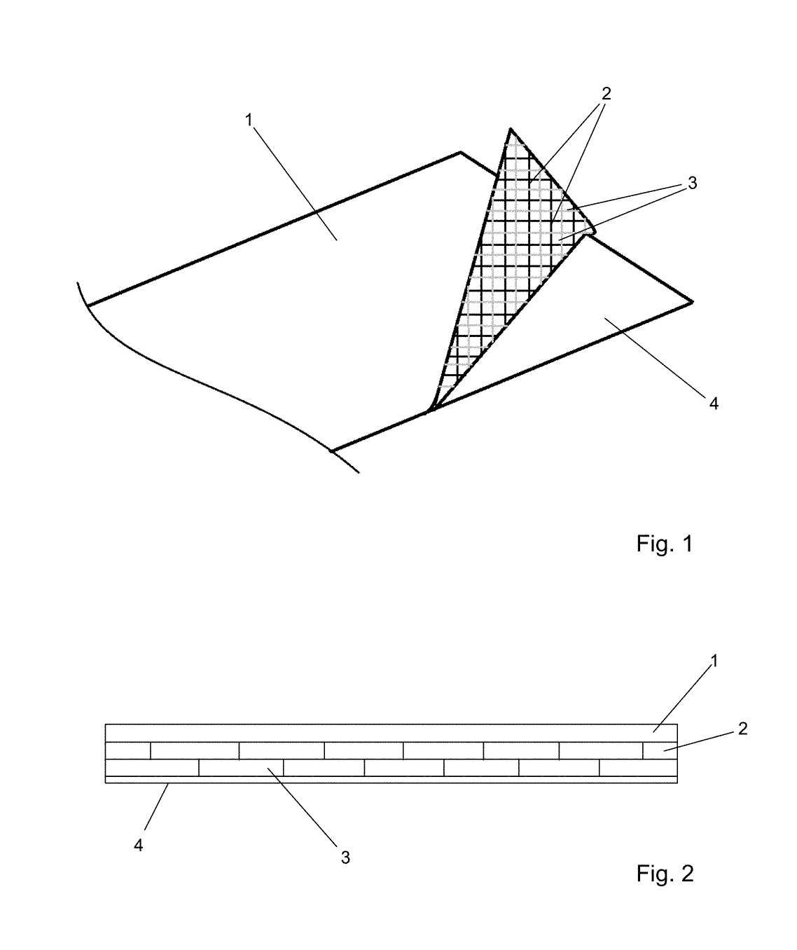

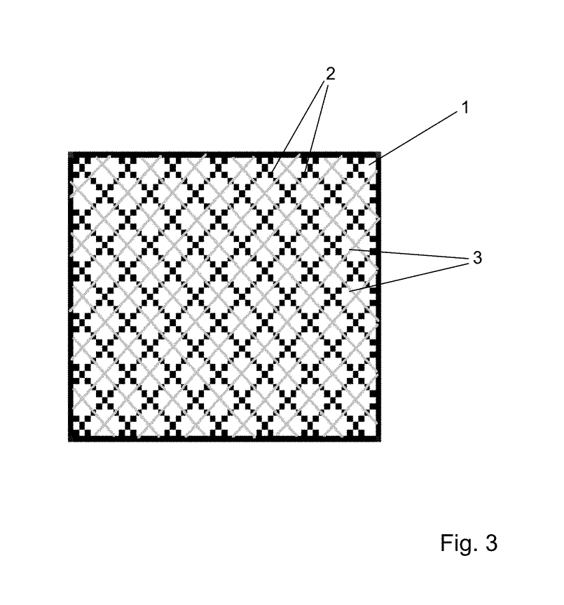

With reference to FIGS. 1 to 3, the adhesive membrane which is airproof and moisture-proof and permeable to water vapor, intended for surfaces of buildings, according to the invention includes a film permeable to water vapor 1, forming the support of the adhesive element according to the invention, of a first layer 2 of a pressure-sensitive adhesive deposited on the lower face of the film 1 in the form of diagonal cords forming crosspieces, illustrated in black lines in FIGS. 1 and 3, and of a second layer 3 of a pressure-sensitive adhesive deposited as diagonal cords forming second crosspieces, illustrated in gray lines in FIGS. 1 and 3, on the lower face of the film and on said first layer 2. The cords of the first layer 2 and of the second layer 3 have a thickness comprised between 50 μm and 2 mm. Moreover, the first layer 2 is obtained in a pressure-sensitive adhesive having a peeling resistance greater than or equal to 2.6 N/cm according to the test method ASTM D3330 of the AAMA 711 standard at a temperature comprised between −30 and 23° C., giving the possibility of providing good adherence at low temperature, i.e. at temperatures corresponding to winter conditions and the second layer 3 is obtained in a pressure-sensitive adhesive having a peeling resistance greater than or equal to 2.6 N/cm according to the test method ASTM D3330 of the AAMA 711 standard at a temperature comprised between 0 and 70° C. It will be noted that the ASTM D3330 tests are conducted on aluminium and/or polyethylene and/or plywood supports.

Said film 1 may consist in any barrier film well known to one skilled in the art and may for example include at least one microporous film or a composite of the latter and/or at least one oriented polymeric film or a composite of the latter and/or at least one polyolefin film or a composite of the latter and/or at least one polypropylene film or a composite of the latter and/or at least one non-woven polyolefin film or a composite of the latter.

Moreover, said first layer 2 of a pressure-sensitive adhesive is obtained in a hot melt glue such as the glue marketed by Collano® under reference L3 752, for example, and said second pressure-sensitive adhesive layer 3 is also obtained in a hot melt glue such as the glue marketed by Bostik under reference TLH 2299E.

However, it is quite obvious that the pressure-sensitive adhesive of the first 2 and second 3 layers may consist in any adhesive which is pressure-sensitive well known one skilled in the art. Such adhesives may consist, for example in acrylate adhesives without however departing from the scope of the invention.

According to an alternative embodiment, not shown in the figures, the first layer 2 of pressure-sensitive adhesive is deposited on the totality of the lower face of the film 1 over a thickness preferably less than 50 μm and the second layer 3 of pressure-sensitive adhesive is deposited as diagonal cords for forming crosspieces. It will be observed that the small thickness of the first layer 2 of pressure-sensitive adhesive only provides a slight reduction in the permeability of the film 1 which is not detrimental to the performance of the membrane.

According to an alternative embodiment, the first and/or the second pressure-sensitive adhesive layer may be deposited as horizontal and/or vertical and/or diagonal strips or else further as horizontal and/or vertical and/or diagonal cords, said strips and/or said cords may be rectilinear or serpentine, in order to form regular or irregular patterns without however departing from the scope of the invention.

Accessorily, with reference to FIGS. 1 and 2, the membrane according to the invention includes a protective film 4 capping the second layer 3 of a pressure-sensitive adhesive. Said protective film 4 consists in any protective film well known to one skilled in the art such as a film including a silicone surface for example.

It is quite obvious that the present invention is by no means limited to the embodiments described above and that many modifications may be provided thereto without departing from the scope of the appended claims.

The embodiments of the invention in which an exclusive property or privilege is claimed are defined as follows:

1. An adhesive element including at least one flexible support comprising an upper face and a lower face, and a pressure-sensitive adhesive layer deposited on the lower face of said support, wherein it includes a first layer of a pressure-sensitive adhesive deposited on all or part of the lower face of the support, the pressure-sensitive adhesive of the first layer having a resistance to peeling greater than or equal to 2.6 N/cm according to the test method ASTM D3330 of the AAMA 711 standard at a temperature comprised between −30 and 23° C., and a second layer of a second pressure-sensitive adhesive deposited on said first layer and/or on all or part of the lower face of the support, the second pressure-sensitive adhesive of the second layer being different from the first adhesive and having a resistance to peeling greater than or equal to 2.6 N/cm according to the test method ASTM D3330 of the AAMA 711 standard at a temperature comprised between 0 and 70° C.

2. The adhesive element according to claim 1, wherein the first pressure-sensitive adhesive layer is deposited on the totality of the lower face of the support over a thickness of less than or equal to 50 μm.

3. The adhesive element according to claim 1, wherein the first and/or the second layer of pressure-sensitive adhesive is deposited as horizontal and/or vertical and/or diagonal strips.

4. The adhesive element according to claim 1, wherein the second layer of pressure-sensitive adhesive is deposited as horizontal and/or vertical and/or diagonal cords.

5. The adhesive element according to claim 1, wherein the first and the second pressure-sensitive adhesive layer are deposited as diagonal cords for forming interlaced crosspieces.

6. The adhesive element according to claim 1, wherein the support includes a film permeable to water vapor.

7. The adhesive element according to claim 6, wherein said film includes at least one microporous film or a composite of the latter.

8. The adhesive element according to claim 6, wherein the film includes at least one oriented polymeric film or a composite of the latter.

9. The adhesive element according to claim 6, wherein the film includes at least one polyolefin film or a composite of the latter.

10. The adhesive element according to claim 6, wherein the film includes at least one polypropylene film or a composite of the latter.

11. The adhesive element according to claim 6, wherein the film includes at least one non-woven polyolefin film or a composite of the latter.

12. The adhesive element according to claim 1, wherein it includes a protective film capping the second layer of pressure-sensitive adhesive.

13. Application of the adhesive element according to claim 6, to an adhesive membrane which is a barrier against air and humidity and permeable to water vapor, intended for surfaces of buildings.
